(19) United States
(12) Patent Application Publication
(10) Pub. No.: US 2018/0170066 A1
(43) Pub. Date: Jun. 21, 2018

(54) LIQUID CIRCULATION MODULE AND LIQUID DISCHARGING APPARATUS

(71) Applicant: TOSHIBA TEC KABUSHIKI KAISHA, Tokyo (JP)

(72) Inventors: Kazuhiko OHTSU, Mishima Shizuoka (JP); Kazuhiro HARA, Numazu Shizuoka (JP); Yoshiaki KANEKO, Mishima Shizuoka (JP)

(21) Appl. No.: 15/684,493

(22) Filed: Aug. 23, 2017

(30) Foreign Application Priority Data
Dec. 21, 2016 (JP) 2016-248355

(51) Int. Cl. B41J 2/19; B41J 2/18

(52) U.S. Cl. CPC B41J 2/19; B41J 2/18

(57) ABSTRACT

A liquid circulation device includes a circulation path through which a liquid circulates to and from a liquid discharging head, the circulation path including a supply flow path on a first side of the liquid discharging head and a collection flow path on a second side of the liquid discharging head, a first tank in the circulation path on the first side of the liquid discharging head, the first tank supplying liquid to the liquid discharging head via the supply flow path and receiving liquid from the liquid discharging head via the collection flow path, a filter in the supply flow path, the filter including an air bubble filter and a before-filter chamber between the first tank and the air bubble filter, and a bypass flow path having a first end fluidly connected to the before-filter chamber and a second end fluidly connected to the collection flow path.

### CROSS-REFERENCE TO RELATED APPLICATION

This application is based upon and claims the benefit of priority from Japanese Patent Application No. 2016-248355, filed Dec. 21, 2016, the entire contents of which are incorporated herein by reference.

### FIELD

Embodiments described herein relate generally to a liquid circulation module and a liquid discharging apparatus.

### BACKGROUND

An existing liquid discharging apparatus, such as an ink jet recording apparatus, includes a circulating type liquid circulation module having a liquid discharging head, which discharges liquid, and a liquid tank, which accommodates liquid to be supplied to the head. The circulation module circulates liquid through a circulation path that passes through the liquid discharging head and the liquid tank. In the circulation module, a filter is provided in the circulation path so that air bubbles, such as those generated in a nozzle of an ink jet head, and foreign substances, such as those entering the nozzle, can be captured and removed from the flow path. The air bubbles that have been captured by the filter are collected in an ink tank using a bypass flow path, which extends from the filter to the circulation flow path, and then are discharged to the outside of the circulation module. The ability to remove air bubbles using a filter may vary depending on characteristics of the ink.

### BRIEF DESCRIPTION OF THE DRAWINGS

FIG. 1 is a side view of an ink jet recording apparatus according to a first embodiment.

FIG. 2 is an explanation view illustrating a structure of a liquid circulation module in an ink jet recording apparatus according to the first embodiment.

FIG. 3 is a view of a structure of an ink jet head in an ink jet recording apparatus according to the first embodiment.

FIG. 4 is a view of a piezoelectric pump in an ink jet recording apparatus according to the first embodiment.

FIG. 5 is a view of a filter unit in an inkjet recording apparatus according to the first embodiment.

FIG. 6 is a view of a pipeline adjustment unit in an ink jet recording apparatus according to the first embodiment.

FIG. 7 is a block diagram of a control system of an ink jet recording apparatus according to the first embodiment.

FIG. 8 is a view of a pipeline adjustment unit in an ink jet recording apparatus according to an embodiment.

FIG. 9 is a view of a pipeline adjustment unit in an ink jet recording apparatus according to an embodiment.

FIG. 10 is a view of a circulation module according to an embodiment.

### DETAILED DESCRIPTION

According to one embodiment, a liquid circulation device includes a circulation path through which a liquid circulates to and from a liquid discharging head, the circulation path including a supply flow path on a first side of the liquid discharging head and a collection flow path on a second side of the liquid discharging head, a first tank in the circulation path on the first side of the liquid discharging head, the first tank supplying liquid to the liquid discharging head via the supply flow path and receiving liquid from the liquid discharging head via the collection flow path, a filter in the supply flow path, the filter including an air bubble filter and a before-filter chamber between the first tank and the air bubble filter, and a bypass flow path having a first end fluidly connected to the before-filter chamber and a second end fluidly connected to the collection flow path.

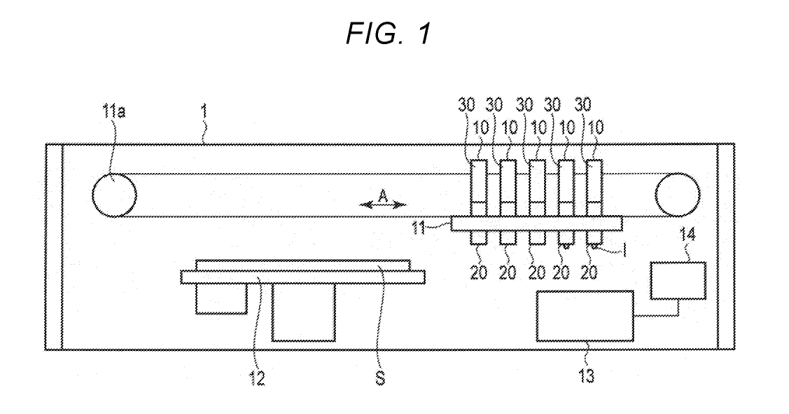

Hereinafter, a liquid circulation module 10 according to a first embodiment and an ink jet recording apparatus 1, which includes the liquid circulation module 10, will be described with reference to FIGS. 1 to 7. In each of the drawings, certain depicted components may have been enlarged, reduced, or omitted for the purposes of clarity in explanation.

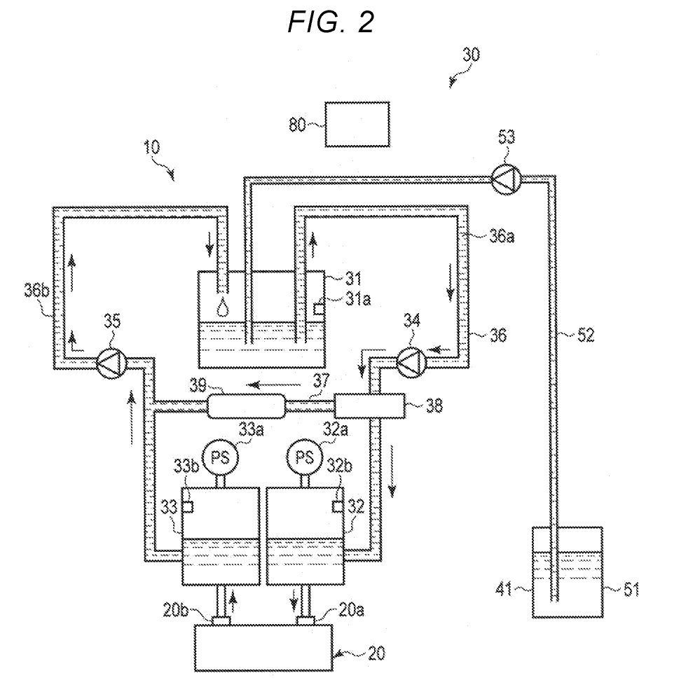

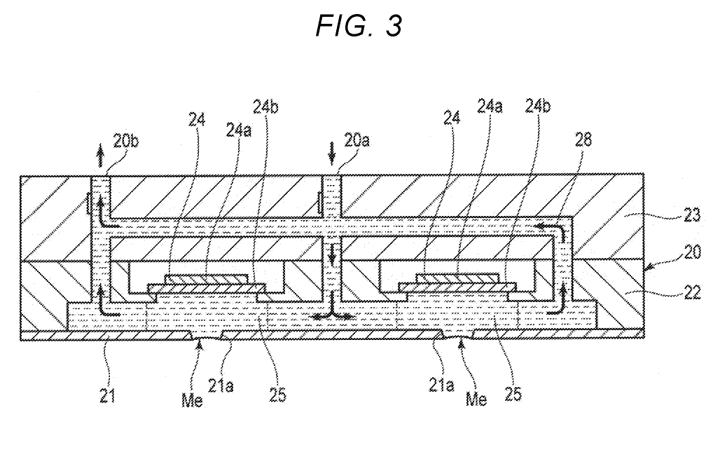

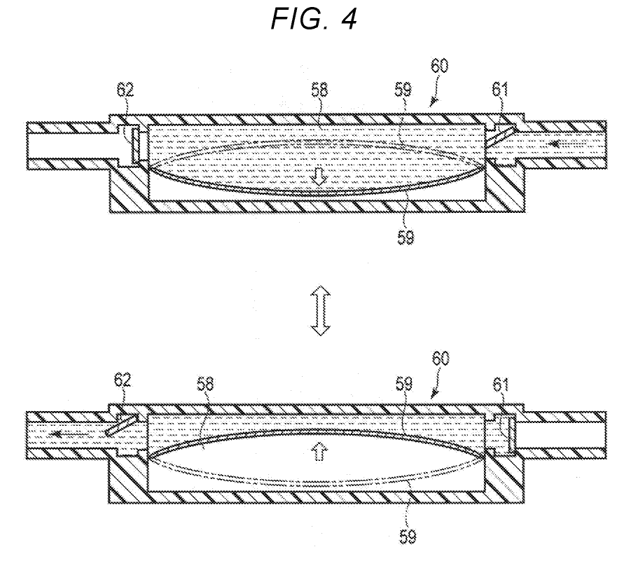

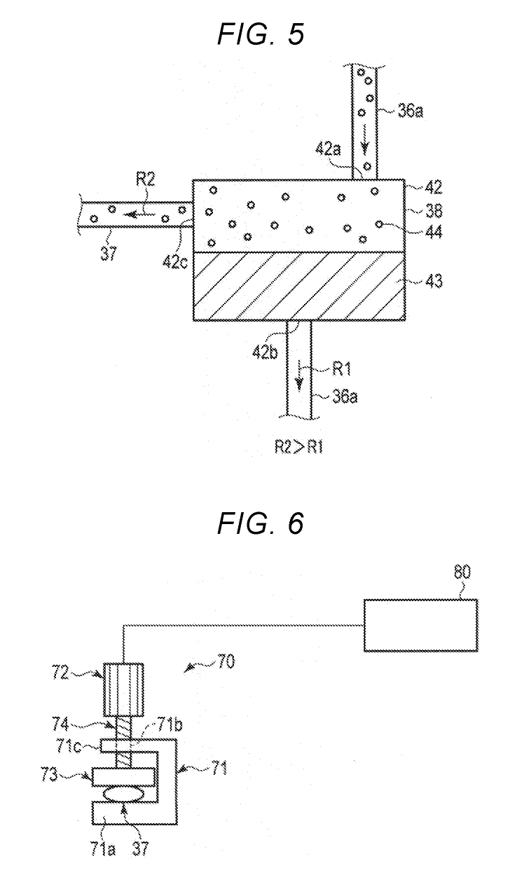

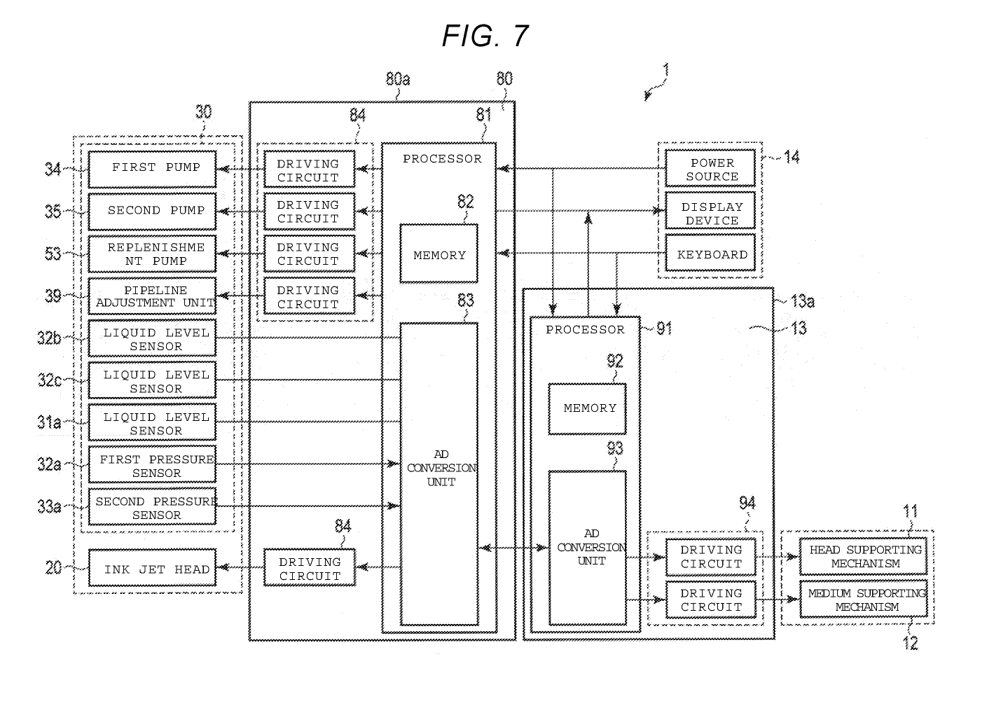

FIG. 1 is a side view of the ink jet recording apparatus 1. FIG. 2 is a view of the liquid circulation module 10. FIG. 3 is a view of a liquid discharging head 20. FIG. 4 is a view i of a first pump 34, a second pump 35, and a replenishment pump 53. FIG. 5 is a view of a filter unit 38. FIG. 6 is a view of a pipeline adjustment unit 39. FIG. 7 is a block diagram of a module controller 80.

The ink jet recording apparatus 1 illustrated in FIG. 1 includes a plurality of liquid circulation modules 10, ahead supporting mechanism 11 that supports the liquid circulation modules 10 such that the liquid circulation modules 10 can move, a medium supporting mechanism 12 that moves and supports a recording medium S, a host controller 13, and an interface unit 14.

As illustrated in FIG. 1, the plurality of liquid circulation modules 10 are arranged in parallel along a predetermined travel direction and are supported by the head supporting mechanism 11. A liquid discharging head 20 and a circulation device 30 are included or integrated in each of the liquid circulation module 10. Each of the liquid circulation modules 10 discharges liquid, for example, ink I, via the liquid discharging head 20, onto the recording medium S facing the liquid circulation modules 10, and forms a desired image on the recording medium S facing the liquid circulation modules 10.

The plurality of liquid circulation modules 10 discharge ink of a plurality of colors, such as cyan ink, magenta ink, yellow ink, black ink, and white ink. However, the colors and/or other characteristics of the ink I to be discharged are not limited. For example, transparent glossy ink, special ink that develops when irradiated with infrared rays or ultraviolet rays, or the like can also be discharged instead of white ink or the like. In general, the various liquid circulation modules 10 have substantially the same configuration and differ only in the ink used therein.

The liquid discharging head 20 illustrated in FIG. 3 is an ink jet head. This liquid discharging head 20 includes a nozzle plate 21, a substrate 22, and a manifold 23, which is bonded to the substrate 22.

The nozzle plate 21 has a rectangular shape. The nozzle plate 21 includes a plurality of nozzle holes 21a.

The substrate 22 has a rectangular shape and is bonded to the nozzle plate 21 such that the substrate 22 faces the nozzle plate 21. A ink flow path 28, which includes a plurality of pressure chambers 25, is formed between the substrate 22 and the nozzle plate 21. The substrate 22 includes a partition portion to separate adjacent pressure chambers 25 from each other. On portions of the substrate 22 that face each pressure chamber 25, actuators 24 are provided.

The actuator 24 is a unimorph type piezoelectric vibration plate which is obtained by stacking a piezoelectric element 24a and a vibration plate 24b. The piezoelectric element 24a is formed of, for example, piezoelectric ceramic material such as lead zirconate titanate (PZT). The vibration plate 24b is formed of, for example, silicon nitride (SiN). The piezoelectric element 24a includes electrodes on the upper and lower portions thereof.

The manifold 23 has a rectangular shape and is bonded to an upper portion of the substrate 22. The manifold 23 includes a supply port 20a and a collection port 20b through which the manifold 23 communicates with the circulation device 30. The manifold 23 is configured to have such a shape that the ink flow path 28 is formed.

In the liquid discharging head 20 depicted in FIG. 3, the pressure chambers 25 are separated from each other by a partition wall. Furthermore, the pressure chambers 25 are formed by the nozzle plate 21, the substrate 22, and the manifold 23 being attached to each other, which also forms the ink flow path 28, which communicates with each pressure chamber 25.

As illustrated in FIGS. 1 and 2, the circulation device 30 is integrally connected to an upper portion of the liquid discharging head 20 via a metal connecting component, for example. The circulation device 30 includes a first tank 31, a second tank 32, a third tank 33, a first pump 34, a second pump 35, a circulation path 36 (including portions 36a, 36b, and 36c), a bypass flow path 37, a filter unit 38, a pipeline adjustment unit 39, and a replenishment unit 41.

The first tank 31 is capable of storing liquid. The first tank 31 is connected to the liquid discharging head 20 along a route through the bypass flow path 37.

The second tank 32 is disposed between the first tank 31 and the liquid discharging head 20 and is capable of storing liquid. The second tank 32 is provided with a first pressure sensor 32a which is an example of a first pressure detecting unit. The second tank 32 is provided with a first liquid level sensor 32b which detects the liquid level in the second tank 32.

The third tank 33 is disposed downstream of the liquid discharging head 20 and is capable of storing liquid. The third tank 33 is provided with a second pressure sensor 33a which is an example of a second pressure detecting unit. In addition, the third tank 33 is provided with a second liquid level sensor 33b which detects the liquid level in the third tank 33.

Each of the first pressure sensor 32a and the second pressure sensor 33a outputs a pressure measurement or reading as an electric signal by using, for example, a semiconductor piezoresistance pressure sensor. The semiconductor piezoresistance pressure sensor includes a diaphragm that receives an external pressure and a semiconductor strain gauge formed on a surface of the diaphragm. The semiconductor piezoresistance pressure sensor detects the pressure state by converting the change in electric resistance caused by a piezoresistance effect in the strain gauge that accompanies the deformation of the diaphragm due to pressure changes into an electric signal.

The first pressure sensor 32a detects the pressure in an air chamber (e.g., a head space) in the second tank 32 and transmits detection data to the module controller 80. The second pressure sensor 33a detects the pressure in an air chamber in the third tank 33 and transmits the detection data to the module controller 80.

The circulation path 36 includes a supply flow path 36a and a collection flow path 36b. The circulation path 36 extends from the first tank 31 to the supply port 20a via the supply flow path 36a and extends from the collection port 20b to the first tank 31 via the collection flow path 36b.

The supply flow path 36a is a flow path extending from the first tank 31 to the supply port 20a. In the supply flow path 36a, the first pump 34 which is a circulation pump, the filter unit 38, and the second tank 32 are sequentially provided.

The collection flow path 36b is a flow path extending from the collection port 20b to the first tank 31. In the collection flow path 36b, the third tank 33 and the second pump 35, which is a circulation pump, are provided.

The supply flow path 36a and the collection flow path 36b are also connected to each other via the bypass flow path 37.

The bypass flow path 37 is a flow path that branches off from the supply flow path 36a at the filter unit 38 and joins the collection flow path 36b. The bypass flow path 37 is provided with the pipeline adjustment unit 39. One end of the bypass flow path 37 communicates with a before-filter chamber 44 (see FIG. 5) of the filter unit 38. The other end of the bypass flow path 37 communicates with a junction portion of the collection flow path 36b. The junction portion is between the third tank 33 and the second pump 35.

Each of the supply flow path 36a, the collection flow path 36b, and the bypass flow path 37 may include a pipe formed of metal or resin material or a tube, for example, a PTFE tube.

Each of the first pump 34, the second pump 35, and a replenishment pump 53 includes, for example, a piezoelectric pump 60. As illustrated in FIG. 4, the piezoelectric pump 60 includes a pump chamber 58, a piezoelectric actuator 59 in the pump chamber 58 that vibrates when a voltage is applied thereto, and check valves 61 and 62 respectively disposed at the inlet and the outlet of the pump chamber 58. The piezoelectric actuator 59 is configured to be capable of vibrating at a frequency of approximately 50 Hz to 200 Hz. The first pump 34, the second pump 35, and the replenishment pump 53 are connected to a driving circuit via wires and are configured to be capable of being controlled by the module controller 80. When AC voltage is applied to operate the piezoelectric actuator 59, the volume of the pump chamber 58 changes. When there is a change in the level of applied voltage, the maximum displacement amount of the piezoelectric actuator 59 changes and the amount of volume change in the pump chamber 58 changes. When the piezoelectric actuator 59 is deformed so as to increase the volume of the pump chamber 58, the check valve 61 at the inlet of the pump chamber 58 opens so that ink flows into the pump chamber 58. When the piezoelectric actuator 59 is deformed so as to decrease the volume of the pump chamber 58, the check valve 62 at the outlet of the pump chamber 58 opens so that ink flows out from the pump chamber 58. The piezoelectric pump 60 feeds the ink I to the downstream side through repetitive expansion and contraction of the pump chamber 58. Accordingly, if a voltage applied to the piezoelectric actuator 59 is increased, the liquid feeding capacity becomes greater and if the voltage is decreased, the liquid feeding capacity becomes smaller. For example, in the present embodiment, the voltage applied to the piezoelectric actuator 59 changes between 50 V to 150 V.

The first pump 34 is provided in the supply flow path 36a of the circulation path 36. The first pump 34 is disposed between the first tank 31 and the liquid discharging head 20 and is disposed upstream of the second tank 32. The first pump 34 feeds liquid in the circulation path 36 to the liquid discharging head 20 disposed downstream thereof.

The second pump 35 is provided in the collection flow path 36b of the circulation path 36. The second pump 35 is disposed between the liquid discharging head 20 and the first tank 31 and is disposed downstream of the third tank 33. The second pump 35 feeds liquid in the circulation path 36 to the first tank 31 disposed downstream thereof.

The filter unit 38 includes a filter case 42 and an air bubble filter 43, which is disposed in the filter case 42. The filter case 42 is configured to have a box-like shape having a top wall, a bottom wall, and side walls, and includes an inflow port 42a, an outflow port 42b, and a branch port 42c. The filter case 42 is configured to be capable of accommodating the air bubble filter 43 and liquid.

The inflow port 42a is an opening which is provided on one end side of the top wall of the filter case 42 and through which the before-filter chamber 44 and the supply flow path 36a communicate with each other.

The outflow port 42b is an opening which is provided on the bottom wall of the filter case 42 and is downstream of the air bubble filter 43. The inner space of the filter case 42 communicates with the supply flow path 36a via the outflow port 42b.

The branch port 42c is an opening which is provided on a side wall of the filter case 42 and through which the before-filter chamber 44 and the bypass flow path 37 communicate with each other.

That is, the before-filter chamber 44 is connected to the first pump 34 through the inflow port 42a and the supply flow path 36a. The before-filter chamber 44 is also connected to the bypass flow path 37 through the branch port 42c. A portion of the filter unit 38 that is on the downstream side of the air bubble filter 43 communicates with the liquid discharging head 20 through the outflow port 42b and the supply flow path 36a.

The air bubble filter 43 is disposed in a lower portion of the filter case 42. Accordingly, the before-filter chamber 44 is formed above the air bubble filter 43 in the filter case 42. Examples of the air bubble filter 43 include a polypropylene filter, a nylon filter, a PVDF filter, a PTFE filter, a polycarbonate filter, a nickel electroformed filter, a stainless filter and the like, of which the average pore diameter is approximately several microns (μm).

Fine air bubbles included in the circulated ink I are blocked by the air bubble filter 43 and the bubbles are caused to flow into the bypass flow path 37 (along with surplus ink I). These bubbles are then collected in the first tank 31 due to the transporting force of the second pump 35, and are subsequently discharged outside of the circulation path 36.

The ink I from which air bubbles have been removed is fed into the liquid discharging head 20 after being transported into the second tank 32 from the outflow port 42b through the supply flow path 36a.

The pipeline adjustment unit 39 is disposed at a predetermined position downstream of the filter unit 38 in the bypass flow path 37. As illustrated in FIG. 6, the pipeline adjustment unit 39 includes a clamping mechanism, for example, a swing jaw tubing clamp type squeezing device 70 (hereinafter, “squeezing device 70”). The squeezing device 70 includes a holding frame 71 including a fixing piece 71a, a rotating unit 72 including a screw 74 that is engaged with the holding frame 71 such that the screw 74 can advance or retreat in an axial direction, and a movable plate 73 which is provided on the tip end of the screw 74.

The holding frame 71 includes, for example, the plate-shaped fixing piece 71a, which is disposed below the bypass flow path 37, and a supporting piece 71c, which is disposed above the fixing piece 71a. The fixing piece 71a and the supporting piece 71c face each other and are integrated with each other in this example. A screw hole 71b including a screw groove, which is engaged with the outer surface of the screw 74, is formed in the supporting piece 71c.

The screw 74 is a shaft-shaped member which includes a inclined spiral portion formed on the outer peripheral surface thereof. When the screw 74 is screwed into the screw groove of the screw hole 71b and advances or retreats in an axial direction according to the rotation of the rotating unit 72, the movable plate 73 provided on the tip end of the screw 74 advances or retreats. The movable plate 73 faces the fixing piece 71a. The bypass flow path 37 is interposed between the movable plate 73 and the fixing piece 71a.

In the pipeline adjustment unit 39, when the rotating unit 72 is rotated manually or is rotated by being controlled by the module controller 80, the movable plate 73 moves according to the rotation of the rotating unit 72 and the gap between the fixing piece 71a and the movable plate 73 increases or decreases such that the pipeline resistance in the bypass flow path 37 changes. That is, it is possible to adjust the pipeline resistance of the bypass flow path 37 by rotating the rotating unit 72.

Regarding the pipeline adjustment unit 39, pipeline conditions can be set through an operation by a user or a control performed by the module controller 80 such that a first pipeline resistance R1 becomes smaller than a second pipeline resistance R2, the first pipeline resistance R1 being the resistance of a first flow path that extends from the filter unit 38 to the junction of the collection flow path 36b through the liquid discharging head 20 and the second pipeline resistance R2 being the resistance of a second flow path that extends from the filter unit 38 to the junction through the bypass flow path 37.

For example, when the user assembles or installs the liquid circulation module 10, it is possible for the user to adjust the pipeline resistance of the bypass flow path 37 by adjusting the squeezing amount of the squeezing device 70 by rotation of the rotating unit 72 and by setting the pipeline adjustment unit 39 in accordance with the characteristics of the ink to be used.

The replenishment unit 41 includes a cartridge 51 which is a replenishment tank provided outside of the circulation path 36, a replenishment path 52, and the replenishment pump 53. The cartridge 51 is capable of retaining ink to be supplied to the first tank 31 and an air chamber in the cartridge 51 is open to the atmosphere. The replenishment path 52 is a flow path that connects the first tank 31 and the cartridge 51. The replenishment pump 53 is provided in the replenishment path 52 and feeds ink in the cartridge 51 to the first tank 31. The replenishment pump 53 is provided in the replenishment path 52. The replenishment pump 53 feeds the ink I in the cartridge 51 toward the first tank 31.

As illustrated in FIG. 7, the module controller 80 includes a processor 81 that controls the operation of each unit and a driving circuit 84 that drives each component. The processor 81 and the driving circuit 84 are on a control board 80a which is installed in the liquid circulation module 10.

The module controller 80 is connected to the interface unit 14 which includes a power source, a display device, an input device, and the like. In addition, the module controller 80 is connected to the host controller 13 and is configured to be capable of communicating with the host controller 13.

The control board 80a has a rectangular shape, for example, and is disposed on a side surface of the circulation device 30 above the liquid discharging head 20.

The processor 81 includes a memory 82 which stores a program, various data, or the like, and an AD conversion unit 83 which converts analog data (voltage value) into digital data (bit data).

The processor 81 corresponds to the central processor unit of the module controller 80. The processor 81 controls each unit in the liquid circulation module 10 such that various functions of the liquid circulation module 10 are achieved according to an operating system or an application program.

The processor 81 is connected to a driving unit of the various pumps or the various sensors in the liquid circulation module 10 and controls the liquid circulation module 10.

When a control process is executed by the processor 81 based on a control program, which is recorded in the memory 82 in advance or is specified by the host controller 13, the module controller 80 functions as a circulation unit, a replenishment unit, a pressure adjustment unit, and a pipeline adjustment unit.

For example, the processor 81 has a function as a circulation unit for circulating ink by controlling the operation of the first pump 34 and the second pump 35. The processor 81 has a function as a replenishment unit for replenishing the circulation path 36 with ink from the cartridge 51 by controlling the operation of the replenishment pump 53 based on the information detected by a liquid level sensor 31a or the pressure sensors 32a and 33a.

The processor 81 captures the information detected by the first pressure sensor 32a, the second pressure sensor 33a, and the liquid level sensor 31a by using the AD conversion unit 83.

The memory 82 is, for example, a non-volatile memory in which various control programs and operation conditions are stored as information required for control of an ink circulation operation, control of an ink replenishment operation, pressure adjustment, and liquid level management.

Furthermore, the processor 81 has a function as a pressure adjustment unit for adjusting the pressure of ink at the nozzle hole 21a by controlling the liquid feeding capacity of the first pump 34 and the second pump 35 based on information detected by the liquid level sensor 31a and/or the pressure sensors 32a and 33a.

The processor 81 has a function as a pipeline adjustment unit for adjusting the pipeline resistance of the bypass flow path 37 by controlling the pipeline adjustment unit 39 based on the information detected by the pressure sensors 32a and 33a.

Hereinafter, a liquid discharging method in the liquid circulation module 10 and a control method for the liquid circulation module 10 will be described.

When an instruction to start ink circulation is detected, for example, receipt of an input operation at the interface unit 14 associated with the processor 81 starting a printing operation, the host controller 13 causes the liquid circulation module(s) 10 to reciprocate in a direction orthogonal to a transportation direction of the recording medium S and the module controller 80 causes the liquid discharging head 20 to perform an ink discharging operation so that an image is formed on the recording medium S.

The host controller 13 includes a processor 91 that controls the operation of each unit and a driving circuit 94 that drives each component. The processor 91 and the driving circuit 94 are on a control board 90a which is installed in the ink jet recording apparatus 1, for example. The host controller 13 is connected to the module controller 80 and is configured to be capable of communicating with the module controller 80.

The processor 91 includes a memory 92 which stores a program, various data, or the like, and an AD conversion unit 93 which converts analog data (voltage value) into digital data (bit data).

The processor 91 corresponds to the central processor unit of the host controller 13. The processor 91 controls each unit in the ink jet recording apparatus 1 such that various functions of the ink jet recording apparatus 1 are realized according to an operating system or an application program. For example, the processor 91 of the host controller 13 moves a carriage 11a, on which the head supporting mechanism 11 is provided, in a direction of the recording medium S and reciprocates in the arrow A direction.

The processor 81 of the module controller 80 selectively drives the actuators 24 of the liquid discharging head 20 by transmitting an image signal according to the image data to the driving circuit 84 of the liquid discharging head 20 so that ink droplets are discharged onto the recording medium S from the nozzle hole 21a.

The processor 81 drives the first pump 34 and the second pump 35 to start the ink circulation operation. The ink I circulates such that the ink I flows out from the first tank 31, reaches the second tank 32 and the liquid discharging head 20, and flows into the first tank 31 again through the third tank 33. Through the circulation operation, impurities in the ink I are removed by the filter unit 38 provided in the circulation path 36. A portion of the circulating ink I is fed into the collection flow path 36b, which is on a collection side, from the filter unit 38 through the bypass flow path 37.

The processor 81 detects the pressure data of the upstream side and pressure data of the downstream side which are transmitted from the first pressure sensor 32a and the second pressure sensor 33a. The processor 81 detects the liquid level in the first tank 31 based on data transmitted from the liquid level sensor 31a.

The processor 81 performs a liquid level adjustment process. Specifically, the processor 81 performs a replenishment operation with ink from the cartridge 51 by driving the replenishment pump 53 based on the result of the detecting operation of the liquid level sensor 31a so as to adjust the position of the liquid surface such that the position falls within an appropriate range. For example, the ink replenishment is performed when ink droplets ID are discharged from the nozzle hole 21a during printing so that the amount of ink in the first tank 31 is momentarily decreased and the liquid surface is lowered. If the amount of ink increases again and the output of the liquid level sensor 31a is inverted, the processor 81 stops the replenishment pump 53.

The processor 81 detects the pressure of ink in a nozzle from the pressure data. Specifically, the pressure of ink in the nozzle hole 21a is calculated using a predetermined formula based on the pressure data of the second tank 32 on the upstream side and the pressure data of the third tank 33 on the downstream side which are transmitted from the pressure sensors 32a and 33a.

For example, it is possible to obtain the pressure Pn of ink in a nozzle by adding the pressure ρgh, where “ρ” indicates the density of ink, “g” indicates the gravitational acceleration, and “h” indicates a distance between the liquid surface in the second tank 32 and the third tank 33 and the nozzle surface in a height direction. is this pressure ρgh is generated due to a difference in the hydraulic head between the height of a liquid surface in the second tank 32 and the third tank 33 and the height of a nozzle surface to the average of a pressure value Ph of an air chamber in the second tank 32 and a pressure value Pl of the third tank 33.

The processor 81 calculates the driving voltage based on the pressure Pn of ink in the nozzle, which is calculated from the pressure data, as a pressure adjustment process. The processor 81 drives the first pump 34 and the second pump 35 such that the pressure Pn of ink in the nozzle becomes an appropriate value. As a result, a negative pressure is maintained such that the ink I does not leak from the nozzle hole 21a and air bubbles are not suctioned via the nozzle hole with a meniscus Me being maintained.

The processor 81 adjusts the pipeline resistance based on the pressure data. Specifically, the processor 81 adjusts the pipeline resistance by controlling the squeezing amount of the squeezing device 70 based on the pressure data of the second tank 32 on the upstream side and the pressure data of the third tank 33 on the downstream side which are transmitted from the pressure sensors 32a and 33a.

The processor 81 controls the output of the first pump 34 and the second pump 35 based on the pipeline resistance of the bypass flow path 37. That is, when there is a change in the flow rate due to the adjustment of the pipeline resistance, the processor 81 controls the operation of the pumps 34 and 35 to adjust the flow rate such that the flow rate is maintained constant.

Since the liquid circulation module 10 configured as described above includes the bypass flow path 37 having a pipeline resistance that is greater than that of the supply flow path 36a which extends from the filter unit 38 to the liquid discharging head 20, it is possible to continuously return air accumulated in the air bubble filter 43 to the first tank 31 and gradually reduce the number of air bubbles in the first tank 31. Accordingly, it is possible to omit an additional operational step/process for removing the air accumulated in the air bubble filter 43 and thus it is possible to continuously use the air bubble filter 43 in printing operations.

Since the bypass flow path 37 is provided with the pipeline adjustment unit 39 as a unit that is capable of changing the pipeline resistance, it is possible to adjust the pipeline resistance according to the type of ink (e.g., an ink in which a large number of air bubbles will be generated or an ink in which a small number of air bubbles will be generated).

Since the processor 81 controls the liquid feeding capacity of the pumps 34 and 35 based on the pipeline adjustment unit 39, it is possible to prevent the flow rate of ink flowing to the head 20 from changing by being influenced by the pipeline adjustment unit 39.

Generally, it is preferable that the pipeline resistance of the bypass flow path 37 is set to be as small as possible to secure the flow rate of the ink flowing to the liquid discharging head 20. However, the pipeline resistance being too small may influence the ability to remove air bubbles, although this also depends on the type of ink. If the ink I in the before-filter chamber 44 is aggressively fed into the bypass flow path 37 with the pipeline resistance of the bypass flow path 37 being too small, the flow rate of ink I flowing to the downstream side of the supply flow path 36a through the air bubble filter 43 decreases and thus it may not be possible to secure a sufficient flow rate of ink I flowing to the liquid discharging head 20. In addition, if the number of captured air bubbles accumulated in the before-filter chamber 44 is excessively large, the pressure in the before-filter chamber 44 may increase since the air bubbles block the pores in the air bubble filter 43, and eventually the pressure may exceed a filter breakthrough pressure, which is a pressure at which air bubbles will pass through the air bubble filter 43. Furthermore, if the state of air bubbles captured in the filter case 42 changes due to physical properties of the ink, such as viscosity and the type of ink such as a water-based ink in which air bubbles generally more likely to be generated, the air bubble removing ability cannot be exhibited and the flow rate of ink flowing to the liquid discharging head 20 side (supply flow path 36a side) may decrease, although this also depends on the pipeline resistance of the bypass flow path 37.

However, in the liquid circulation module 10 and the ink jet recording apparatus 1 according to the first embodiment, since the bypass flow path 37 has a pipeline resistance that can be adjusted, it is possible to maintain an appropriate pipeline resistance of the bypass flow path 37 to secure the flow rate of ink I flowing to the liquid discharging head 20.

The present disclosure is not limited to the particulars of the above described example embodiments and various components may be modified without departing from the spirit of the present disclosure.

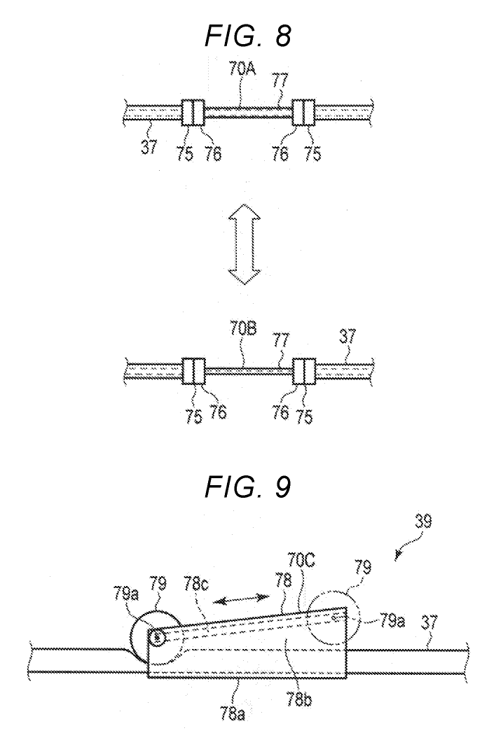

For example, in the first embodiment, squeezing device 70 is used as component of the pipeline adjustment unit 39. However, the disclosure is not limited to this particular device. For example, a pipeline adjustment unit 39A, which is illustrated in FIG. 8, has a configuration in which a plurality of pipe members with different pipeline resistances and the pipeline resistance can be varied by switching out or attaching to each other the different pipe members. As shown, the pipeline adjustment unit 39A is configured such that a portion of the bypass flow path 37 can be replaced. That is, a portion of the bypass flow path 37 can be detached and replaced by one of the pipe members 70A and 70B, which have different pipeline resistance. For example, a joint 75 is provided on the bypass flow path 37 side at each of the opposite ends of the replaceable flow path 77 and a joint 76 which can be connected to the joint 75 is provided on each of the opposite ends of the pipe members 70A and 70B. For example, the pipe members 70A and 70B can be different in conditions such as inner diameter and/or length.

In the first embodiment, the pipeline adjustment unit 39 is provided in the bypass flow path 37 so that it is possible to distribute a flow path according to the characteristics of the ink and to maintain a high air bubble removing ability.

In addition, a roller tubing clamp type squeezing device 70C, as illustrated in FIG. 9, may be adopted as the pipeline adjustment unit 39 in some embodiments. The roller tubing clamp type squeezing device 70C includes a U-shaped holder 78 that includes a bottom wall 78a and a pair of side walls 78b and a roller 79 which is movably supported by the holder 78. A groove 78c that obliquely extends is formed on each of the side walls of the holder 78. A shaft 79a of the roller 79 is rotatably supported in the groove 78c. The bypass flow path 37 is interposed between the roller 79 and the bottom wall 78a of the U-shaped holder 78. If the roller 79 in the squeezing device 70C obliquely moves, a flow path sectional area of the pipeline of the bypass flow path 37 increases or decreases. Accordingly, it is possible to adjust the pipeline resistance of the bypass flow path 37 by adjusting the position of the roller 79.

Similarly, for example, the pipeline adjustment unit 39 may be configured such that the bypass flow path 37 is provided with an electrically operated variable valve which is connected to the module controller 80. For example, it is possible to control the pipeline resistance by adjusting the openness of the variable valve through the control of the module controller 80.

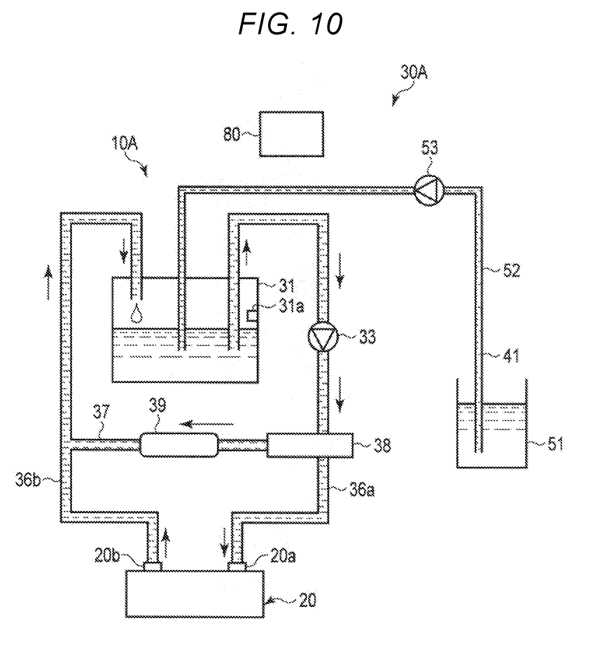

In addition, a configuration of the circulation device is also not limited to that in the first embodiment and a configuration in which the second tank 32, the third tank 33, and the second pump 35 may be omitted as in the case of a circulation module 10A and a circulation device 30A, illustrated in FIG. 10, may be adopted in some embodiments. The circulation device 30A includes the first tank 31 storing liquid, the first pump 34, the circulation path 36, the bypass flow path 37, the filter unit 38, the pipeline adjustment unit 39, and the replenishment unit 41. Other configurations are the same as those in the circulation device 30 according to the first embodiment, and have the same effect as the first embodiment. That is, since the pipeline adjustment unit 39 is provided in the bypass flow path 37 which extends from the filter unit 38 and joins the collection flow path 36b, it is possible to adjust the distribution of fluid from the filter unit 38 and to maintain a high air bubble removing ability.

The liquid to be discharged is not limited to ink and, in general, any liquid other than ink may be discharged. Examples of a liquid discharging apparatus that discharges liquid may include a device that discharges liquid containing conductive particles for forming a wiring pattern of a printed circuit board.

In addition to the above-described configuration, the liquid discharging head 20 may have a configuration in which ink droplets are discharged with a vibration plate being deformed due to static electricity or a configuration in which ink droplets are discharged from a nozzle by using thermal energy from a heater or the like.

In the above-described example, a liquid discharging apparatus of an ink jet recording apparatus 1 is described. However, the disclosure is not limited to this usage and the liquid discharging apparatus can be used as a part of a 3D printer or an industrial manufacturing machine, for medical purposes, and can vary in assorted ways to be reduced in size, weight, and cost.

As the first pump 34, the second pump 35, and the replenishment pump 53, a tube pump, a diaphragm pump, or a piston pump may be used instead of the piezoelectric pump 60.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid circulation device, comprising:
a circulation path through which a liquid circulates to and from a liquid discharging head, the circulation path including a supply flow path on a first side of the liquid discharging head and a collection flow path on a second side of the liquid discharging head;
a first tank in the circulation path on the first side of the liquid discharging head, the first tank supplying liquid to the liquid discharging head via the supply flow path and receiving liquid from the liquid discharging head via the collection flow path;
a filter in the supply flow path, the filter including an air bubble filter and a before-filter chamber between the first tank and the air bubble filter; and
a bypass flow path having a first end fluidly connected to the before-filter chamber and a second end fluidly connected to the collection flow path.

2. The liquid circulation device according to claim 1, further comprising:
a first pump in the supply flow path between the first tank and the filter;
a second tank in the supply flow path between the filter and the liquid discharging head;
a third tank in the collection flow path between the liquid discharging head and the second end of the bypass flow path;
a first pressure sensor configured to detect a pressure in the second tank; and
a second pressure sensor configured to detects a pressure in the third tank.

3. The liquid circulation device according to claim 2, further comprising:
a pipeline resistance adjuster in the bypass flow path; and
a controller configured to control the pipeline resistance adjuster to change a pipeline resistance of the bypass flow path based on the pressures detected by the first pressure sensor and the second pressure sensor.

4. The liquid circulation device according to claim 3, wherein the pipeline resistance adjuster is a squeezing device including a movable plate and a fixed plate between which a cross-sectional area of the bypass flow path can be adjusted.

5. The liquid circulation device according to claim 3, wherein the pipeline resistance adjuster is a variable valve.

6. The liquid circulation device according to claim 3, wherein the controller controls the first pump based on the pipeline resistance of the bypass flow path.

7. The liquid circulation device according to claim 2, wherein the first pump is a piezoelectric pump.

8. A liquid discharging apparatus, comprising:
a liquid discharging head;
a circulation path through which a liquid circulates to and from a liquid discharging head, the circulation path including a supply flow path on a first side of the liquid discharging head and a collection flow path on a second side of the liquid discharging head;
a first tank in the circulation path on the first side of the liquid discharging head, the first tank supplying liquid to the liquid discharging head via the supply flow path and receiving liquid from the liquid discharging head via the collection flow path;
a filter in the supply flow path, the filter including an air bubble filter and a before-filter chamber between the first tank and the air bubble filter;
a bypass flow path having a first end fluidly connected to the before-filter chamber and a second end fluidly connected to the collection flow path; and
a moving device that moves a recording medium relative to the liquid discharging head.

9. The liquid discharging apparatus according to claim 8, further comprising:
a first pump in the supply flow path between the first tank and the filter;
a second tank in the supply flow path between the filter and the liquid discharging head;
a third tank in the collection flow path between the liquid discharging head and the second end of the bypass flow path;
a first pressure sensor configured to detect a pressure in the second tank; and
a second pressure sensor configured to detects a pressure in the third tank.

10. The liquid discharging apparatus according to claim 9, further comprising:
a pipeline resistance adjuster in the bypass flow path; and
a controller configured to control the pipeline resistance adjuster to change a pipeline resistance of the bypass flow path based on the pressures detected by the first pressure sensor and the second pressure sensor.

11. The liquid discharging apparatus according to claim 10, wherein the pipeline resistance adjuster is a squeezing device including a movable plate and a fixed plate between which a cross-sectional area of the bypass flow path can be adjusted.

12. The liquid discharging apparatus according to claim 10, wherein the pipeline resistance adjuster is a variable valve.

13. The liquid discharging apparatus according to claim 10, wherein the controller controls the first pump based on the pipeline resistance of the bypass flow path.

14. The liquid discharging apparatus according to claim 9, wherein the first pump is a piezoelectric pump.

15. A liquid circulation device comprising:
a circulation path through which a liquid circulates to and from a liquid discharging head, the circulation path including a supply flow path on a first side of the liquid discharging head and a collection flow path on a second side of the liquid discharging head;
a first tank in the circulation path on the first side of the liquid discharging head, the first tank supplying liquid to the liquid discharging head via the supply flow path and receiving liquid from the liquid discharging head via the collection flow path;
a filter in the supply flow path, the filter including an air bubble filter and a before-filter chamber between the first tank and the air bubble filter;
a bypass flow path having a first end fluidly connected to the before-filter chamber and a second end fluidly connected to the collection flow path;
a pipeline resistance adjuster in the bypass flow path; and
a controller configured to control the pipeline resistance adjuster to change a pipeline resistance of the bypass flow path.

16. The liquid circulation device according to claim 15, further comprising:
a first pump in the supply flow path between the first tank and the filter;
a second tank in the supply flow path between the filter and the liquid discharging head;
a third tank in the collection flow path between the liquid discharging head and the second end of the bypass flow path;
a first pressure sensor configured to detect a pressure in the second tank; and
a second pressure sensor configured to detects a pressure in the third tank, wherein
the controller controls the pipeline resistance adjuster based on pressures detected by the first pressure sensor and the second pressure sensor.

17. The liquid circulation device according to claim 16, wherein the controller controls the first pump based on the pipeline resistance of the bypass flow path.

18. The liquid circulation device according to claim 16, wherein the first pump is a piezoelectric pump.

19. The liquid circulation device according to claim 15, wherein the pipeline resistance adjuster is a squeezing device including a movable plate and a fixed plate between which a cross-sectional area of the bypass flow path can be adjusted.

20. The liquid circulation device according to claim 15, wherein the pipeline resistance adjuster is a variable valve.
